(19) United States
(12) Patent Application Publication
(10) Pub. No.: US 2014/0359312 A1
(43) Pub. Date: Dec. 4, 2014

(54) POWER ON WITH NEAR FIELD COMMUNICATION

(71) Applicants: Moishe Halibard, Herzliya (IL); Itamar Sharoni, Modiin (IL)

(72) Inventors: Moishe Halibard, Herzliya (IL); Itamar Sharoni, Modiin (IL)

(21) Appl. No.: 13/908,385

(22) Filed: Jun. 3, 2013

(51) Int. Cl. G06F 1/26

(52) U.S. Cl. CPC G06F 1/26
USPC 713/300

(57) ABSTRACT

A system for powering up a computer having a central processing unit (CPU), which CPU includes an operating system (OS), when the CPU is in an Sx state in which the (OS) is not powered up. There is a near field communication (NFC) detector for detecting an NFC signal, and an embedded controller physically separate from said CPU, the embedded controller responsive to the NFC signal and adapted to power up the CPU out of said Sx state.

### BACKGROUND

1. Field of the Invention

This disclosure pertains to wireless communication and more particularly to near field communication (NFC) devices and methods.

2. Description of the Related Art

Since the advent of Near Field Communication (NFC) and similar technologies, it is now possible to simplify and automate many functions by having an NFC device on a system platform detect the presence of an NFC token, such as a smart card, mobile phone etc., and the detection triggers the NFC device to activate the function. In particular. it is possible to unlock the system and perform security and authentication functions. Likewise, it is possible to implement and simplify two factor authentication systems, which require both some knowledge, like a password, in addition to the token.

However, current implementations of NFC and similar technologies require a booted operating system (OS) with relevant software installed, and do not operate in pre-boot and pre-OS environments, nor on PCs which in are powered off, or in sleep or hibernated states, all of which are referred to herein as Sx states. Therefore, no use case exists for NFC in these scenarios.

### BRIEF DESCRIPTION OF THE DRAWINGS

The invention will become clearly understood from the following detailed description read together with the drawings in which:

FIG. 1 is a generalized diagrammatic view illustrating one example of a system that can be powered on by NFC even when not booted;

FIG. 2 is diagram showing an exemplary flow for powering on the system of FIG. 1;

FIG. 3 is a block circuit diagram of another example of a system in which an NFC tag may be used to power on a system;

FIG. 4 is flow chart showing a process for powering on a system using an NFC tag such as the system of FIG. 3;

FIG. 5 is a block diagrammatic view of an embodiment of system in which an active mode NFC device may be used to power on the system; and

FIG. 6 is flow chart illustrating an embodiment of a power-on process for the system of FIG. 5.

### DETAILED DESCRIPTION OF EMBODIMENTS

The embodiments disclosed herein relate to near field communication (NFC). NFC is a technology for short distance wireless transmission that operates at 13.56 megahertz (MHz) over an air interface at specific rates ranging from 106 kbits per second to 424 kbits per second. The 13.56 MHz frequency is an unlicensed frequency. NFC avoids interference because its range is severely limited, usually twenty centimeters or less. NFC devices are built according to standards developed by the International Organization for Standardization IOS) and by the International Electrotechnical Commission.(IEC), in particular, the ECMA-340 and ISO/IEC 18092 standards. Other standards are also applicable, such as standards promulgated by the NFC Forum. A detailed explanation of NFC can be found in NFC Tags, a Technical Introduction, Applications and Products—White Paper, Rev. 1.3 Dec. 2011. An example of this paper can be found on line at www.nfctags.com/documents/White_paper_NFC%20Tags_NXP_Technical %20rep ort_December_{—}2011.pdf which is published by the NFC Forum.

NFC devices can be either passive or active. A passive device is often referred to as a tag, and is similar to a radio frequency identification device (RFID) tag, but of shorter range. Typically a passive tag contains less than a few kbytes of information that can be read by an active NFC device, but it cannot receive any communication from another device. In passive communication, an initiator device provides an electromagnetic carrier field which the passive device modulates. As in RFID, the passive device may derive power from the initiator. In NFC active mode, both devices generate their own fields. NFC communication activates automatically when two NFC devices are touched or otherwise brought close together.

The following describes apparatus and processes which can be used to utilize NFC to power up a device, such as a PC that is in an Sx state, and, in particular, can power up a PC when the PC OS is not booted up. In an embodiment, the system includes an NFC capable device and an embedded controller, where the term “embedded” has its normal meaning in the art. That is, it indicates that the controller is designed to perform a specific task, as contrasted to a CPU which is a general purpose device designed to do a variety of tasks. In particular, the embedded controller is physically separate from the CPU. Both the NFC capable device, and the embedded controller may be powered on while the system is in an Sx state. The embedded controller may have the ability to power on the system.

The NFC capable device on the PC may detect the NFC token, and communicate it to the embedded controller. The embedded controller may then authenticate the token, and send a power up signal to the system. Additionally, it can pass the authentication information to the PC logon, or to the pre-boot system. An example of an embedded controller separate from the CPU, and which can be connected to NFC and which can be powered on in Sx states, is the Intel® Management Engine (ME) running on the Platform Controller Hub (PCH).

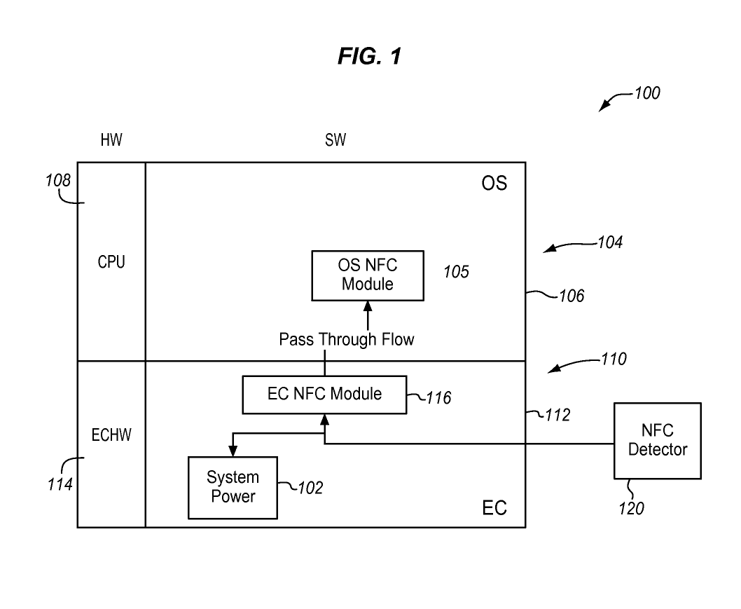

Turning first to FIG. 1, a generalized block functional diagram of an embodiment 100 of such a NFC responsive system is shown. System 100 includes a PC 104 and an embedded controller 110. PC 104 includes a hardware portion 108 that includes a CPU and a software portion 106 that includes the PC operating system 106 and the operating system 105 for an NFC module. Embedded controller 110 includes embedded hardware 114 and an embedded NFC software module 116. A power source 102 provides power to the embedded controller and to the PC. System 100 also includes an NFC signal detector 120, which, as discussed in more detail below, may include an NFC antenna. The NFC module 116 is connected to NFC detector 120.

To better understand the embodiments, it is useful to consider the different terms that relate to how NFC is used to turn on a computer, such as a PC 104 having a CPU 108. In this disclosure, we shall refer to an “NFC token”. In this disclosure, “token” means an information signal output by an NFC device in response to an NFC tap, i.e. the data exchange that occurs when two NFC devices are brought together. It may include information identifying or validating an NFC device and may include authentication information. It may be in a standard form for an NFC message, such as the NDEF specification published by the NFC Forum. In discussing how the embodiments process such a token, we shall use terms such as “recognize”, “validate”, “authenticate”, and “authorize”. These terms refer to different levels of security for the processing. The lowest level is recognition of a token. This level has minimum security. At this level, the system only determines that the token is in a form that can be received by the NFC device. In one embodiment, this means that the token is in a digital form that can pass information to the NFC device. The next level of security is designated as “validation”, or that the processing determines the token is “valid”. At this level, the NFC device has processed the token and determined that it matches a signal stored in either the NFC device or the embedded controller. This has a higher level of security in that the signal that it matches is previously stored in some part of the system, and other signals are rejected. A higher level of security is indicated by the term “authenticate” or authentication. This level means that a secure communication process is used to match the token to information stored in the NFC system or embedded controller. For example, the secure communication process may include encryption or hashing. A fourth level of security is indicated by the term “authorize”. This term means that the token is in a form that has been predetermined to permit a specific operation, such as the operation or waking or powering up the CPU. One or more of these levels of security may be used by the embodiments described.

It will also be seen that a variety of different electronic embodiments are presented herein. So as not to be unduly lengthy, not all of the different levels of security are shown or described with each of the different electronic embodiments. However, it should be understood that each of the different security levels can be implemented in each of the different electronic embodiments, and after understanding the full disclosure, one skilled in the art will understand how to implement each of the various combinations or electronic systems with each of the different security levels. One skilled in the art will also understand that other electronic structures and security processes can be implemented within the scope of the disclosure.

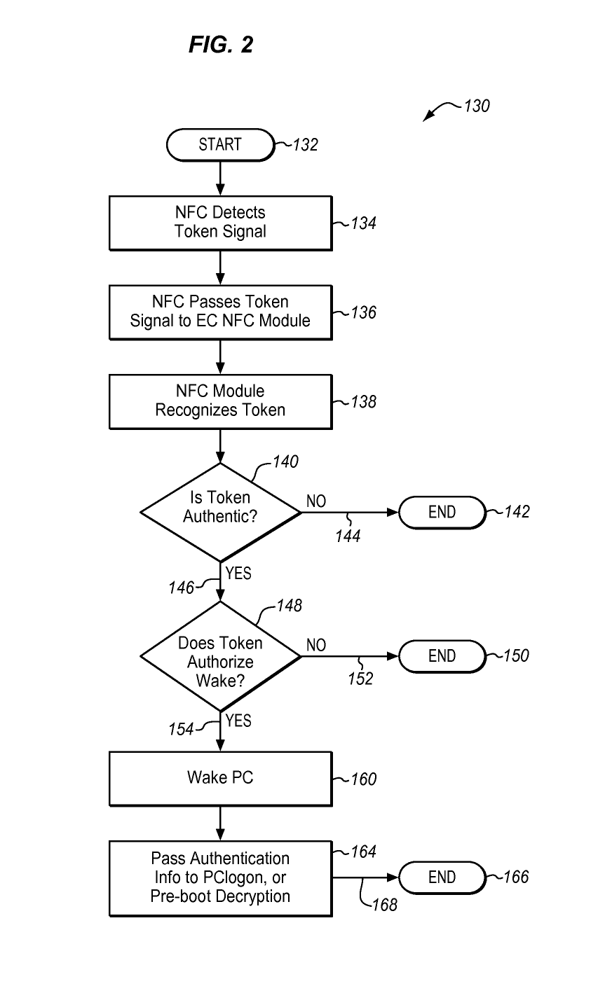

FIG. 2 is a flow diagram illustrating one embodiment of a process 130 for operation of the system of FIG. 1. Process 130 starts at 132. In sub-process 134, NFC system 116, 120 detects a token. The NFC token is passed to ECNFC module 116 in sub-process 136. The token is decoded, recognized at 138, and optionally authenticated at 140. Examples of such an authentication process are given below. If the ECNFC module does not recognize the token, or the authentication process fails, the process goes to 142 via 144. If the token is recognized, and if any authentication is positive, the process goes to 148 via 146. In process 148 NFC module 116 determines if the token authorizes a PC wake process. If the token does not authorize a wake process, the process goes to 150 via 152 and the process ends. If the token. Does authorize a wake process, the NFC module 116 powers on the PC 104 at 160. As an option, any authentication information received by module 116 may be passed to PC 104 in sub-process 164. The process 130 then goes to 166 via 168 where the process ends.

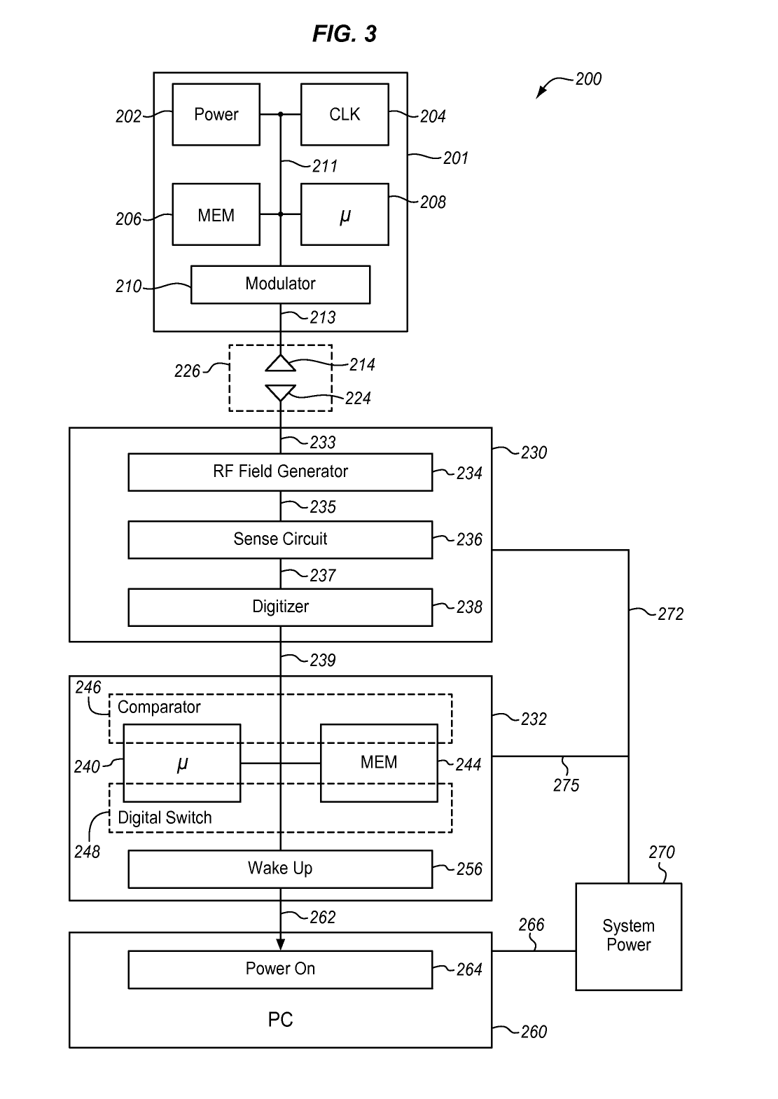

FIG. 3 is a block diagram of an embodiment 200 of a system that utilizes a NFC passive tag 201 to power on a PC 260. In addition to tag 201 and PC 260, system 200 includes NFC detect circuit 230, embedded controller 232, and system power module 270. In one embodiment, NFC detect circuit is a discrete circuit separate from embedded controller 232, and in another embodiment, it is integrated into embedded controller 232. Tag 201 comprises power module 202, clock 204, memory 206, microprocessor 208, and modulator 210, which communicate via bus 211, and antenna 214. Modulator 210 is electrically connected to antenna 226 via connector 213. NFC circuit 230 comprises antenna 224, RF field generator 234, sense circuit 236 for sensing changes in the RF field generated by generator 234, and digitizer 238 which digitizes the signal sensed by sense circuit 236 and outputs a signal on line 239. Embedded controller 232 comprises microprocessor 240, memory 244, and wake up trigger circuit 256 electrically connected with bus 241. Together antennas 214 and 224 may comprise a transformer core. In one embodiment, microprocessor 240 and memory 244 are adapted to form a comparator 246 and a digital switch 248. Antenna 224 is electrically connected to RF field generator 234 via line 233, RF field generator 234 is electrically connected to sense circuit 236 via line 235, and sense circuit 236 is electrically connected to digitizer 238 via line 237. Digitizer 238 is connected to embedded controller via line 239. Microprocessor, 240, memory 244 and wake-up trigger 250 are connected via bus 255. PC 260 includes power on circuit 264. The output signal from wake up circuit 256 is applied to power on circuit 264 of PC 260 via line 262. System power is provided by power module 270 and is applied to NFC circuit 230 via line 272, to embedded controller 232 via line 275 and to PC via line 266. As known in the art, clock 204 may be integrated into memory 206 or microprocessor 208 and modulator 210 may be implemented by memory 206 and/or microprocessor 208.

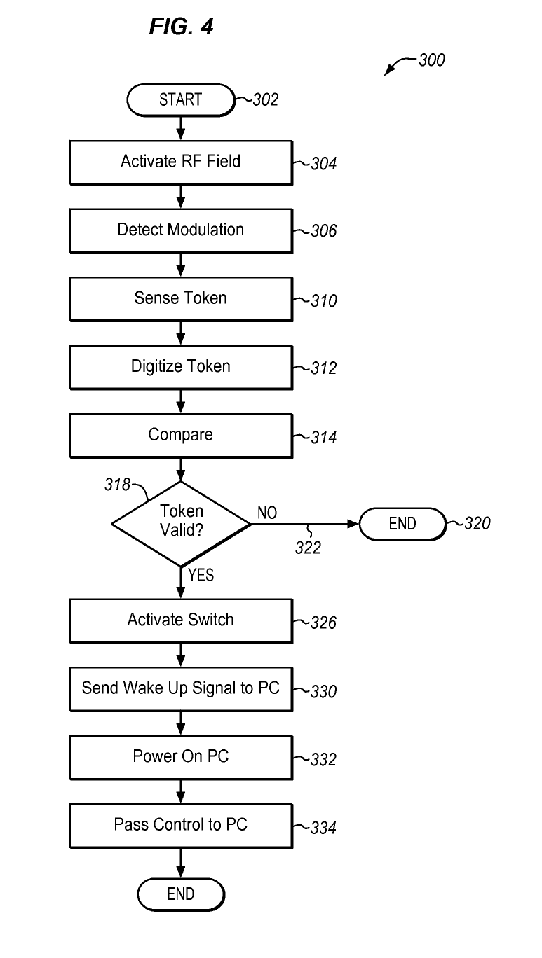

FIG. 4 is a flow chart illustrating one embodiment of a process 300 of operating system 200. Process 300 starts at 302. In sub-process 304, the RF field generator 234 is activated. At 306, the modulation of the field by tag 201 is detected. At 310, the modulation is analyzed by sense circuit to sense the token communicated by tag 201. The token is digitized at 312. At 314 the token is compared to a reference stored in memory 244. If the token does not correlate to the reference, the token is declared as not valid at 318 and the process passes to 320 via 302 and the process ends. If the token is valid, switch 240 is activated in sub-process 326. At 330, the switch activates wake-up circuit 250 which sends a wake-up signal to PC 260. The PC powers on at 332, and control is passed to the PC at 334 after which process 300 ends at 340.

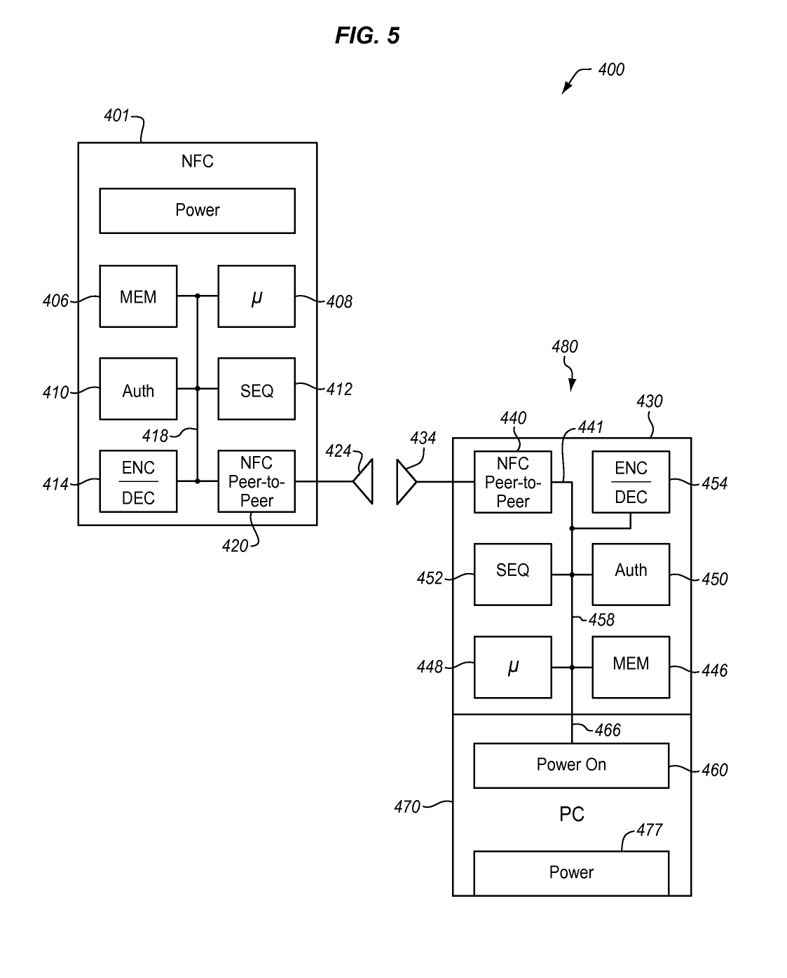

FIG. 5 is a block circuit diagram of a system 400 which utilizes an active NFC device 401 to power on a PC 470. System 400 includes active NFC device 401, NFC detector 440, and a computer 480 that includes an embedded controller 430 and a PC 460, which controller is capable of powering on the PC 470. The NFC detector 440 is an active NFC device, which may be discrete or may be embedded in computer 480. In the embodiment described, the computer is a PC 470.

NFC device 401 may comprise memory 406, microprocessor 408, authentication circuit 410, sequencer 412, encryption/decryption circuit 414, and NFC peer-to-peer circuit 420, all of which are connected via bus 418. NFC device 401 also includes a power source 402 which is connected to all of the foregoing circuit elements, though the connections are not shown. Device 401 also includes an antenna 424 which is connected to NFC peer-to-peer module 420. Embedded controller 430 may comprise memory 446, microprocessor 448, authentication circuit 450, sequencer 452, encryption/decryption module 454, all of which are connected via bus 458. NFC detector 440 includes NFC antenna 434 which is connected to NFC peer-to-peer module 440. In both device 401 and embedded controller 430, the authentication circuit, such as 410 and 450, the sequencer, such as 412 and 452 and the encryption/decryption circuits 414 and 454 may be implemented by configurations of memories 406 and 446 and microprocessors 408 and 448. PC 470 includes a power-on circuit 460 and a power source 477 as well as other elements of a computer. Power source 477 also provides power to the other components of computer 480, including NFC device 440. If NFC detector 440 is discrete, an output 441 may be connected to controller 430, and if it is embedded in controller 430 it may be connected to bus 458. An output 466 of controller 430 is connected to power-on circuit 460.

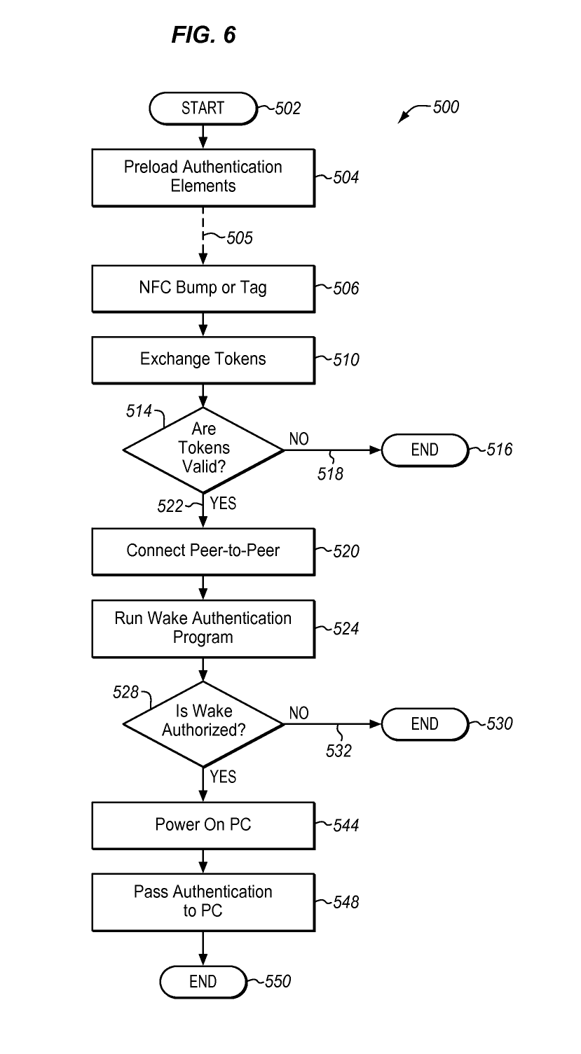

FIG. 6 is a flow chart illustrating one embodiment of a process 500 of operating system 400. Process 500 starts at 502 and flows to sub-process 504 for preloading authentication elements into NFC device 401 and controller 430. In sub-process 506, the NFC process is initiated by a bump or tag 506 in which NFC device 401 is brought into proximity with NFC device 440. One use case for the system 400 may be that NFC device 401 is packaged with computer 480. In such a use case, the preload sub-process 504 may take place at the factory or may be performed after the computer 480 is purchased. In this and other use cases, there may be a significant amount of time between preload sub-process 504 and bump or tag 506 which is indicated by the dotted line 505. Preload process 504 may comprise an authentication circuit or chip 410 incorporated into NFC device 401 and an authentication circuit or chip 450 incorporated into NFC device 440 at manufacture. It may comprise encryption elements being loaded into circuits 414 and 454 at setup of these circuits. It may comprise hash functions being loaded into memories 406 and 446 at set up. Either of the forgoing may include sequence elements being loaded into sequencers 412 and 452. At 510, NFC devices 401 and 440 exchange tokens. The tokens are compared at 514 to determine if they match. If they do not match, or otherwise indicate that the two NFC devices are part of a system 400, the process passes to 516 via 518 and the process ends. If the tokens match, the process 500 proceeds to 520 where the peer-to-peer communication link is automatically set up. The process 500 then proceeds to 524 where a wake authentication program is run. Wake authentication program 524 may depend on what authentication elements were uploaded in sub-process 504, and may include an exchange between authentication circuits 410 and 450, an encryption algorithm, a hash function or many other possible authentication processes. At 528, system 400 determines if wake of computer 480 is authorized. If it is not authorized, the process 500 passes to 530 via 532 and the process ends. If wake is authorized, process 500 passes to 544 and a signal is passed via output 466 to power-on circuit 460 and PC 470 is powered on. Optionally, authentication elements may be passed from controller 430 to PC 470. At 550, process 500 ends.

There is a system to power up a computer having a central processing unit (CPU), which CPU includes an operating system (OS), the CPU adapted to be in an Sx state in which the CPU is powered off, in a pre-boot state, in a sleep state or in a hibernated state, the system further comprising: a near field communication (NFC) device to detect a near field communication(NFC) signal; and an embedded controller physically separate from the CPU, the embedded controller adapted to be responsive to the NFC signal to power up the CPU out of the Sx state. In one embodiment, the NFC detector is physically separate from or electronically integrated with the embedded controller. In another embodiment, the signal is encrypted and the embedded controller is adapted to perform decryption or wherein the signal contains a hash value and the embedded controller is adapted to determine the hash value. In one embodiment, the NFC device is an active NFC device. In another embodiment, the NFC device is adapted to perform NFC peer-to-peer communications. In a further embodiment, the NFC device comprises an antenna. In another embodiment, the NFC device comprises an radio frequency (RF) field generator. In a further embodiment, the system further comprises a sensor to sense changes in the RF field and produce a sensed signal. In an alternative embodiment, the NFC device comprises a digitizer to digitize the sensed signal. In another embodiment, the embedded controller comprises a memory.

There is also a method for powering up a computer in response to a near field communication (NFC) signal, the computer having a central processing unit (CPU), the method comprising: detecting an NFC signal including an NFC token; communicating the token to an embedded controller, the embedded controller separate and distinct from the CPU, validating that the token comes from an NFC device with authority to power up the CPU, the validation performed with the embedded controller; and responsive to the NFC signal, powering up the CPU. In one embodiment, the embedded controller includes a memory and the validating comprises comparing the token to a value stored in the memory. In another embodiment, the method further includes authenticating the NFC token. In a further embodiment, the NFC signal is encrypted and the authenticating comprises decryption of the signal. In another embodiment, the NFC token is encoded in a hash function and the authenticating comprises decoding the hash function. In an additional embodiment, the method further includes passing the authentication information to the CPU. In another embodiment, the passing comprises passing the authentication information to the PC at logon or at preboot.

There is also an article comprising a non-transitory machine readable medium storing instructions, the instructions, when executed by one or more processors, cause the processor to perform operations including: detecting a near field communication (NFC) token; and, responsive to the token, cause an embedded controller to power up the CPU. In one alternative, the machine readable medium includes instructions for determining if the token authorizes the power up of the CPU. In another alternative, the token is encrypted and the machine readable medium includes instructions for decrypting the token.

There is also a system for powering on a computer in an Sx state using near field communication (NFC), the system comprising: an NFC means for detecting a near field communication (NFC) signal and, responsive to the NFC signal, providing a power up signal; and an embedded controller means, the embedded controller means responsive to the power up signal for a powering up the computer when it is in an Sx state. In one embodiment, the NFC means comprises an active NFC device. In another embodiment, the embedded controller means comprises a memory and a microprocessor.

In another embodiment, there is a machine readable medium including code, when executed, to cause a machine to perform the method of any one of the above methods.

In yet a further embodiment, there is a near field communication (NFC) system, comprising: a token means for producing an NFC token for powering up a central processing unit (CPU); a modulator means communicating with the token means for modulating a radio frequency signal to include the NFC token; and an antenna means for transmitting the NFC token. In one alternative, the token means further includes a means for indicating that the token is valid to power up the CPU. In another embodiment, the system further comprises a means for encrypting the NFC token. In a further embodiment, the token means comprises a microprocessor and a memory. In another embodiment, the token means further includes a clock.

In another embodiment, there is an apparatus comprising means to perform any of the methods described above.

There have been described novel NFC methods, systems and devices. Now that embodiments of the NFC system have been described, those skilled in the art will be able to adapt them to other methods, systems and devices. It will also be evident to those skilled in the art that the various parts of embodiments may be combined in many different ways. It should be understood that each of the processes and apparati described can be combined with any of the other processes and apparati. After review of this disclosure, additional embodiments, advantages and modifications will readily appear to those skilled in the art. The system is therefore is not limited to the illustrative examples shown and described, but is defined by the following claims.

What is claimed is:

1. A system to power up a computer having a central processing unit (CPU), which CPU includes an operating system (OS), said CPU adapted to be in an Sx state in which said CPU is powered off, in a pre-boot state, in a sleep state or in a hibernated state, said system further comprising:
a near field communication (NFC) device to detect a near field communication (NFC) signal; and
an embedded controller physically separate from said CPU, said embedded controller adapted to be responsive to said NFC signal to power up said CPU out of said Sx state.

2. A system as in claim 1 wherein said NFC detector is physically separate from or electronically integrated with said embedded controller.

3. A system as in claim 1 wherein said signal is encrypted and said embedded controller is adapted to perform decryption or wherein said signal contains a hash value and said embedded controller is adapted to determine said hash value.

4. A system as in claim 1 wherein said NFC device is an active NFC device.

5. A system as in claim 1 wherein said NFC device is adapted to perform NFC peer-to-peer communications.

6. A system as in claim 1 wherein said NFC device comprises an antenna.

7. A system as in claim 1 wherein said NFC device comprises an radio frequency (RF) field generator.

8. A system as in claim 7 and further comprising a sensor to sense changes in said RF field and produce a sensed signal.

9. A system as in claim 1 wherein said NFC device comprises a digitizer to digitize said sensed signal.

10. A system as in claim 1 wherein said embedded controller comprises a memory.

11. A method for powering up a computer in response to a near field communication (NFC) signal, said computer having a central processing unit (CPU), said method comprising:
detecting an NFC signal including an NFC token;
communicating said token to an embedded controller, said embedded controller separate and distinct from said CPU;
validating that said token comes from an NFC device with authority to power up said CPU, said validation performed with said embedded controller; and
responsive to said NFC signal, powering up said CPU.

12. A method as in claim 11 wherein said embedded controller includes a memory and said validating comprises comparing said token to a value stored in said memory.

13. A method as in claim 11 and further including authenticating said NFC token.

14. A method as in claim 13 wherein said NFC signal is encrypted and said authenticating comprises decryption of said signal.

15. A method as in claim 13 where said NFC token is encoded in a hash function and said authenticating comprises decoding said hash function.

16. A method as in claim 13 and further including passing said authentication information to said CPU.

17. A method as in claim 16 wherein said passing comprises passing said authentication information to said PC at logon or at preboot.

18. An article comprising a non-transitory machine readable medium storing instructions, the instructions, when executed by one or more processors, cause the processor to perform operations including: detecting a near field communication (NFC) token; and, responsive to said token, cause an embedded controller to power up said CPU.

19. An article as in claim 18 wherein said machine readable medium includes instructions for determining if said token authorizes said power up of said CPU.

20. An article as in claim 18 wherein said token is encrypted and said machine readable medium includes instructions for decrypting said token.
